(19) United States
(12) Patent Application Publication
(10) Pub. No.: US 2010/0244388 A1
(43) Pub. Date: Sep. 30, 2010

(54) SEALING DEVICE

(75) Inventors: Takehiro Nakagawa, Fukushima (JP); Akihiro Komyo, Fukushima (JP)

Correspondence Address: HARNESS, DICKEY & PIERCE, P.L.C., P.O. BOX 828, BLOOMFIELD HILLS, MI, 48303, US

(73) Assignee: NOK CORPORATION, Tokyo (JP)

(21) Appl. No.: 12/682,763

(22) PCT Filed: Dec. 10, 2008
(86) PCT No.: PCT/JP2008/072366

§ 371 Date: Apr. 12, 2010

(30) Foreign Application Priority Data
Dec. 17, 2007 (JP) 2007-324137
Jul. 15, 2008 (JP) 2008-183859

(51) Int. Cl. F16J 15/32; F16C 33/76

(52) U.S. Cl. 277/559

(57) ABSTRACT

To prevent entry of muddy water, a sealing device (1) has an oil seal (10) mounted in an opening end portion (2a) of a non-rotating housing (2) and a slinger (20) mounted on a rotating body (5), the oil seal (10) is integrally formed of a rubber-like elastic material on a metal reinforcement ring (11) and has the oil seal lip (13) slidably contacting with the rotating body (5), the reinforcement ring (11) has an outer diameter tube portion (11b) having no rubber-like elastic material and extending in the direction opposite to the opening end portion (2a) to surround the outer periphery of the slinger (20), and an outer seal lip (24) extending in the direction opposite to the opening end portion (2a) is mounted on a rim portion (23) of the slinger (20) to slidably contact with the inner peripheral surface of the outer diameter tube section (11b).

### CROSS-REFERENCE TO RELATED APPLICATIONS

This is a national stage of the International Application No. PCT/JP2008/072366 filed on Dec. 10, 2008 and published in the Japanese language. This application claims the benefit of Japanese Application No. 2007-324137, filed on Dec. 17, 2007 and Japanese Application No. 2008-183859, filed on Jul. 15, 2008. The disclosures of the above applications are incorporated herein by reference.

### BACKGROUND OF THE INVENTION

1. Field of the Invention

The present invention relates to a sealing device sealing a shaft periphery and the like of a portion which tends to be exposed to muddy water or the like from an external portion, such as a transfer apparatus, a wheel bearing apparatus and the like of a vehicle, and more particularly to a sealing device provided with a structure preventing muddy water or the like from making an intrusion into a sliding portion of an oil seal lip.

2. Description of the Conventional Art

In a sealing device used for a transfer apparatus, a wheel bearing apparatus and the like of a vehicle, since muddy water or the like tends to come in splashily from an external portion, it is necessary to inhibit muddy water or the like from making an intrusion into a sliding portion of an oil seal lip as much as possible, thereby preventing a reduction of a sealing performance in the oil seal lip as much as possible. FIG. 4 is a half sectional view of an installed state to show an example of this kind of sealing device in accordance with a conventional art by cutting along a plane passing through an axis O.

In particular, in FIG. 4, reference numeral 2 denotes a housing of a transfer apparatus, reference numeral 3 denotes a rotating shaft which is inserted to the housing 2 and is supported in a state of being rotatable around an axis O via a bearing 4, reference numeral 5 denotes a sleeve which is spline fitted to an outer periphery of the rotating shaft 3 and is fixed by a nut 6, and reference numeral 7 denotes a packing which seals between the rotating shaft 3 and the sleeve 5. A companion flange 5a formed in an end portion of the sleeve 5 is connected to a propeller shaft (not shown) or the like.

A sealing device 100 is provided with a non-rotating oil seal 110 which is positioned at an outer side in an axial direction of the bearing 4 and is attached to an inner periphery of the housing 2, and a slinger 120 which is positioned at an outer side in an axial direction of the oil seal 110, is attached to an outer periphery of the sleeve 5, and is rotated integrally with the rotating shaft 3 and the sleeve 5.

Describing in detail, the oil seal 110 has an oil seal lip 111 which extends toward the bearing 4 side, and a side lip 112 which extends toward an opposite side to the oil seal lip 111 (an outer side). The oil seal lip 111 is structured such as to prevent a lubricating oil fed to the bearing 4 from leaking by being slidably brought into close contact with an outer peripheral surface of the sleeve 5, and the side lip 112 is structured such as to prevent muddy water or the like coming in splashily from an external portion A from making an intrusion into the oil seal lip 111 side by being slidably brought into close contact with a flange portion 121 of the slinger 120. The slinger 120 itself has a throwing off action on the basis of centrifugal force generated in the flange portion 121. Further, an improvement of an effect of preventing muddy water or the like from making an intrusion is achieved by bringing an outer diameter portion 122 thereof near an end portion of the housing 2 (refer, for example, to Japanese Unexamined Patent Publication No. 2006-9930, Japanese Unexamined Utility Model Publication No. 5-54871, and Japanese Unexamined Utility Model Publication No. 3-67765), or by providing a conical tubular dust lip, in which a leading end has a large diameter, on an outer diameter end portion of the slinger 120 to bring it slidably in close contact with an outer diameter edge portion of the housing 2 (refer, for example, to Japanese Utility Model Publication No. 7-33017).

Reference is made to Japanese Unexamined Patent Publication No. 2006-9930, Japanese Unexamined Utility Model Publication No. 5-54871, Japanese Unexamined Utility Model Publication No. 3-67765, and Japanese Utility Model Publication No. 7-33017.

However, in accordance with the sealing device 100 as shown in FIG. 4 (refer to Japanese Unexamined Patent Publication No. 2006-9930, Japanese Unexamined Utility Model Publication No. 5-54871, and Japanese Unexamined Utility Model Publication No. 3-67765), if a gap G between the outer diameter portion 122 of the slinger 120 and the outer peripheral surface of the end portion of the housing 2 is made small for enhancing a shielding effect with respect to a foreign material or the like, there is a risk that the outer diameter portion 122 comes into contact with the outer peripheral surface of the end portion of the housing 2 on the basis of a working tolerance, an eccentricity of the rotating shaft 3 or the like, so that it is hard to make the gap G sufficiently small.

Further since, in an outer peripheral space of the side lip 112, there are generated such a flow that muddy water is scattered to an outer diameter side from the gap G on the basis of a throw-off action of the slinger 120, and such a flow that muddy water is accordingly going to make an intrusion into a portion in the vicinity of the side lip 112 from the gap G, that is, since a violent beating flow as shown by an arrow F is generated, there is a problem that the side lip 112 tends to be exposed to an abrasion.

Further, in the sealing device in which the outer diameter end portion of the slinger 120 is provided with the conical tubular dust lip in which the leading end has the large diameter like as the patent publication 4, since a body portion of the dust lip comes into close contact with an outer diameter edge of an opening end portion of the housing 2, the housing 2 is generally manufactured by casting, where a dimensional tolerance is great, a dispersion of a fastening margin of the dust lip with respect to the housing 2 is thus large, and in addition the housing 2 made of a cast product has a rough surface, the dust lip tends to wear in an early stage. Further, since centrifugal force applied by rotation operates in such a manner as to open the dust lip, there is pointed out a risk that a sealing performance of the dust lip is lowered in accordance with an increase of a rotating speed.

### SUMMARY OF THE INVENTION

### Problem to be Solved by the Invention

The present invention is made by taking the points mentioned above into consideration, and a technical object of the present invention is to provide a structure which can prevent muddy water or the like from making an intrusion into a sliding portion of an oil seal lip as much as possible, in a sealing device sealing a shaft periphery or the like of a portion which tends to be exposed to muddy water or the like from an external portion.

### Means for Solving the Problem

As a means for effectively solving the technical problem mentioned above, in accordance with a first aspect of the present invention, there is provided a sealing device comprising:

an oil seal attached to an inner peripheral surface of an opening end portion of a non-rotating housing; and

a slinger attached to a rotating body inserted to the housing so as to be positioned at an outer side in an axial direction of the oil seal,

the oil seal being integrally formed on a reinforcing ring made of a metal by a rubber-like elastic material,

wherein an oil seal lip slidably brought into close contact with an outer peripheral surface of the rotating body is formed, an outer diameter tube portion, which is exposed from the rubber-like elastic material, is directed to an opposite side to the opening end portion of the housing and extends in such a manner as to surround an outer peripheral side of the slinger, is formed in the reinforcing ring, and an outer seal lip provided on a rim portion of the slinger so as to be directed to an opposite side to the opening end portion of the housing is slidably brought into close contact with an inner peripheral surface of the outer diameter tube portion.

Further, in accordance with a second aspect of the present invention, there is provided a sealing device comprising:

an oil seal attached to an inner peripheral surface of an opening end portion of a non-rotating housing;

a slinger attached to a rotating body inserted to the housing so as to be positioned at an outer side in an axial direction of the oil seal; and

an outer diameter flange attached to the housing so as to be positioned at an outer diameter side of the oil seal,

wherein the oil seal has an oil seal lip slidably brought into close contact with an outer peripheral surface of the rotating body, an outer diameter tube portion extending so as to be directed to an opposite side to the opening end portion of the housing from an outer diameter end portion thereof is provided extendedly on the outer diameter flange, a protruding portion nearby opposed to the outer diameter flange via a gap in an axial direction, and a rim portion nearby opposed to an inner peripheral surface of the outer diameter tube portion via a gap in a radial direction are formed on an outer diameter portion of the slinger, and a labyrinth-shaped non-contact seal is formed by the gap in the radial direction and the gap in the axial direction.

### EFFECT OF THE INVENTION

In accordance with the sealing device on the basis of the first aspect of the present invention, since the outer seal lip provided on the rim portion of the slinger is slid in a close contact manner with the inner peripheral surface of the outer diameter tube portion extended from the reinforcing ring, it is possible to effectively prevent muddy water from making an intrusion into a sliding portion side of the oil seal lip. Further, since centrifugal force applied to the outer seal lip by rotation, and muddy water pressure in the external portion in the case that the sealing device is submerged into muddy water operate in such a manner as to increase the close contact surface pressure of the outer seal lip with respect to the inner peripheral surface of the outer diameter tube portion, an excellent muddy water sealing performance can be obtained.

In accordance with the sealing device on the basis of the second aspect of the present invention, since the labyrinth-shaped non-contact seal is formed by the gap in the radial direction between the outer diameter tube portion of the outer diameter flange and the rim portion of the slinger, and the gap in the axial direction between the outer diameter flange and the protrusion portion of the slinger, it is possible to effectively prevent muddy water from making an intrusion into the oil seal lip side without causing an increase of a torque.

### BRIEF EXPLANATION OF DRAWINGS

FIG. 1 is a half sectional view of an installed state to show a first embodiment of a sealing device in accordance with the present invention by cutting along a plane passing through an axis O;

FIG. 2 is a half sectional view of an installed state to show a second embodiment of a sealing device in accordance with the present invention by cutting along a plane passing through an axis O;

FIG. 3 is an enlarged sectional view of a substantial part in FIG. 2; and

FIG. 4 is a half sectional view of an installed state to show an example of a sealing device in accordance with a conventional art by cutting along a plane passing through an axis O.

### DETAILED DESCRIPTION OF PREFERRED EMBODIMENTS

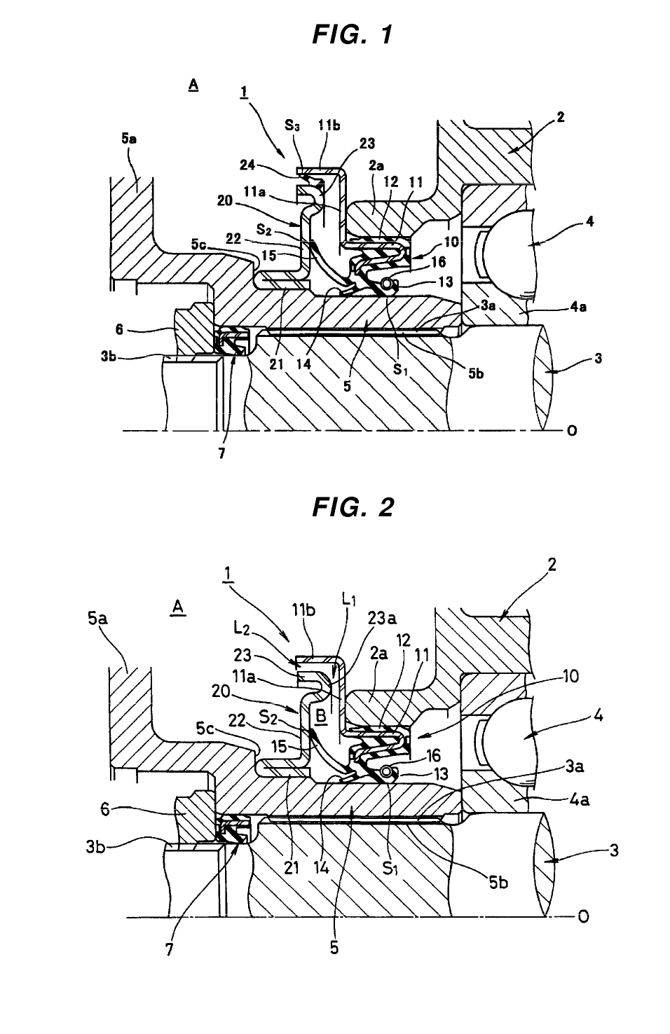

A description will be given below of embodiments of a sealing device in accordance with the present invention with reference to the accompanying drawings. FIG. 1 is a half sectional view of an installed state to show a first embodiment of the sealing device in accordance with the present invention by cutting along a plane passing through an axis O.

In this FIG. 1, reference numeral 2 denotes a non-rotating housing in a transfer apparatus of a vehicle, reference numeral 3 denotes a rotating shaft inserted to the housing 2 and supported in a state of being rotatable around an axis O via a bearing 4, and reference numeral 5 denotes a sleeve positioned at an inner peripheral side of an opening end portion 2a of the housing 2 so as to be outside inserted to the rotating shaft 3. In this case, the rotating shaft 3 and the sleeve 5 correspond to the rotating body described in the first aspect.

The sleeve 5 is structured such that a spline portion 5b which is formed on an inner peripheral surface thereof is fitted to a spline portion 3a which is formed on an outer peripheral surface of the rotating shaft 3, and the sleeve 5 is fixed in an axial direction by a nut 6, which is positioned at an outer side in an axial direction from the spline portions and is engaged with a male thread portion 3b formed on an outer peripheral surface of the rotating shaft 3, in a state in which a leading end is brought into contact with an inner ring 4a of the bearing 4. A portion between the rotating shaft 3 and the sleeve 5 is sealed by a packing 7 which is positioned at an outer side in an axial direction from the fitted portion of the spline portions 3a and 5b so as to be interposed, and is prevented by the nut 6 from coming off. Further, a companion flange 5a is formed in an outer end portion of the sleeve 5, and is connected to a propeller shaft (not shown) or the like.

Reference numeral 1 denotes a sealing device in accordance with the present invention. The sealing device 1 is provided with an oil seal 10 which is attached to an inner peripheral surface of the opening end portion 2a of the housing 2, and a slinger 20 which is attached to an outer peripheral surface of the sleeve 5 outside inserted to the rotating shaft 3, in a state of being positioned at an outer side in an axial direction of the oil seal 10.

The oil seal 10 is integrally formed by a rubber-like elastic material (a rubber material or a synthetic resin material having a rubber-like elasticity) on a reinforcing ring 11 which is, for example, manufactured by punching and press molding of a metal plate, and is provided with an outer peripheral seal portion 12 which is pressure inserted and fitted to the inner peripheral surface of the opening end portion 2a of the housing 2, an oil seal lip 13 which extends to the bearing 4 side from an inner diameter position of the reinforcing ring 11 and is slidably brought into close contact with the outer peripheral surface of the sleeve 5 by an inner peripheral portion in the vicinity of a leading end, a dust lip 14 which extends to an opposite side to the oil seal lip 13 from the inner diameter position of the reinforcing ring 11 and is closely opposed to or is slidably brought into close contact with the outer peripheral surface of the sleeve 5 by a leading end inner periphery thereof, and a side lip 15 which extends to an opposite side to the oil seal lip 13 from an outer peripheral side of a root of the dust lip 14 so as to form such a conical tubular shape that a leading end has a large diameter. A garter spring 16 compensating tension force is fitly attached to the oil seal lip 13.

An outer diameter flange 11a and an outer diameter tube portion 11b which are exposed from the outer peripheral seal portion 12 made of a rubber-like elastic material are extendedly provided on an outer diameter portion of the reinforcing ring 11 of the oil seal 10. Describing in detail, the outer diameter flange 11a of the reinforcing ring 11 extends to an outer diameter side along a leading end of the opening end portion 2a of the housing 2, and the cylindrical outer diameter tube portion 11b directed to an opposite side to the opening end portion 2a of the housing 2 is provided extendedly from an outer diameter end portion thereof.

The slinger 20 is manufactured by punching and press molding of the metal plate, and has an inner diameter tube portion 21 which is pressure inserted and fitted to the outer peripheral surface of the sleeve 5, and a seal flange portion 22 which is expanded in a disc shape in a radially outer direction from the inner diameter tube portion 21 so as to be slidably brought into close contact with the leading end portion of the side lip 15 of the oil seal 10. Further, a rim portion 23 formed in an approximately U-shaped fold shape protruding toward the outer diameter flange 11a side of the reinforcing ring 11 in its cross sectional shape is provided on an outer diameter side of the seal flange portion 22 and the outer diameter tube portion 11b of the reinforcing ring 11 of the oil seal 10 is provided extendedly in such a manner as to surround an outer peripheral side of the rim portion 23.

An outer peripheral surface of the rim portion 23 of the slinger 20 is integrally provided with an outer seal lip 24 made of a rubber-like elastic material or a low friction synthetic resin material such as PTFE (a polytetrafluoroethylene) or the like. The outer seal lip 24 is formed in a conical tubular shape having a large diameter in its leading end as well as being directed to an opposite side to the opening end portion 2a of the housing 2, and an outer peripheral edge of the leading end is slidably brought into close contact with an inner peripheral surface of the outer diameter tube portion 11b of the reinforcing ring 11, thereby forming a sliding portion S₃.

In the sealing device 1 in accordance with the present invention constructed as mentioned above, the oil seal 10 is positioned and fixed to the housing 2, by pressure inserting the outer peripheral seal portion 12 in which the reinforcing ring 11 is embedded, to the inner peripheral surface of the opening end portion 2a, and bringing the outer diameter flange 11a of the reinforcing ring 11 into contact with the leading end of the opening end portion 2a of the housing 2. On the other hand, the slinger 20 is positioned and fixed to the sleeve 5 by pressure inserting and fitting the inner diameter tube portion 21 to the outer peripheral surface of the sleeve 5 and bringing the inner diameter tube portion 21 into contact with a step surface 5c formed in the outer peripheral surface of the sleeve 5, and then the sleeve 5 is outside inserted to the rotating shaft 3 so as to be fixed, whereby an illustrated installed state is achieved.

The oil seal lip 13 of the oil seal 10 is structured such as to prevent a lubricating oil fed to the bearing 4 from leaking to an external portion A through the outer periphery of the sleeve 5, at a sliding portion S₁ with the outer peripheral surface of the sleeve 5. Further, the side lip 15 of the oil seal 10 is structured such as to block an intrusion of muddy water or the like into an inner peripheral side from an external portion A on the basis of a close contact sliding motion with the seal flange portion 22 and a throwing off operation of the seal flange portion 22 by centrifugal force, at the sliding portion S₂ with the seal flange portion 22 of the rotating slinger 20, and the dust lip 14 of the oil seal 10 is structured such as to block an intrusion of muddy water or the like into the oil seal lip 13 side by being closely opposed to or being slidably brought into close contact with the outer peripheral surface of the sleeve 5 at an inner peripheral side of the side lip 15.

Further, at an outer side from the sliding portions of the oil seal lip 13, the dust lip 14 and the side lip 15, the outer seal lip 24 provided on the rim portion 23 of the slinger 20 slidably comes into close contact with the inner peripheral surface of the outer diameter tube portion 11b extending from the reinforcing ring 11 in such a manner as to surround the outer peripheral side of the slinger 20 while being directed to the opposite side to the opening end portion 2a of the housing 2, thereby forming the sliding portion S₃. Therefore, it is possible to effectively prevent muddy water or the like coming in splashily from the external portion A from making an intrusion into the sliding portion S₂ of the side lip 15.

Further, since the outer seal lip 24 is formed in the conical tubular shape in which the leading end is large in diameter, and the outer peripheral edge of the leading end is brought into close contact with the inner peripheral surface of the outer diameter tube portion 11b of the reinforcing ring 11, the centrifugal force applied on the basis of the rotation operates in such a manner as to increase the close contact surface pressure of the outer seal lip 24 with respect to the inner peripheral surface of the outer diameter tube portion 11b of the reinforcing ring 11, whereby it is possible to effectively prevent muddy water coming in splashily from making an intrusion.

Further, since the outer seal lip 24 is directed to the opposite side to the opening end portion 2a of the housing 2 (the external portion A side), in the case, for example, that the vehicle travels in a state in which a whole of an illustrated portion is submerged in muddy water, muddy water pressure of the external portion A operates in such a manner as to increase the close contact surface pressure of the outer seal lip 24 with respect to the inner peripheral surface of the outer diameter tube portion lib of the reinforcing ring 11, so that it is possible to effectively prevent muddy water from making an intrusion.

Further, since the reinforcing ring 11 is manufactured by punching and press molding of the metal plate, and the outer peripheral surface of the outer diameter tube portion 11b is smooth in comparison with the outer peripheral surface of the opening end portion 2a of the housing 2 constructed by a cast product, particularly in the case that the outer seal lip 24 is made of the low friction synthetic resin material such as PTFE or the like, an abrasion resistance is improved as well as the sliding torque at the sliding portion S₃ is held down, and an excellent muddy water sealing performance can be maintained over a long period of time.

Further, since the rim portion 23 of the slinger 20 is formed in the approximately U-shaped fold shape protruding toward the outer diameter flange 11a side of the reinforcing ring 11, and the outer diameter tube portion 11b protrudes toward the external portion A from the housing 2, a heat dissipation area is large, and accordingly, heat generated in the sliding portion S₃ between the outer seal lip 24 and the outer diameter tube portion 11b is effectively discharged.

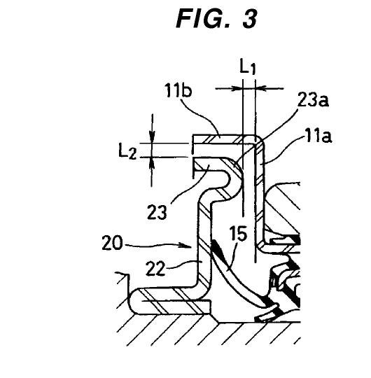

Next, FIG. 2 is a half sectional view of an installed state to show a second embodiment of the sealing device in accordance with the present invention by cutting along a plane passing through an axis O, and FIG. 3 is an enlarged sectional view of a substantial part of FIG. 2.

This embodiment is different from the first embodiment mentioned above in a point that a labyrinth-shaped non-contact seal is formed by a gap L₂ in a radial direction between the outer diameter tube portion lib of the reinforcing ring 11 and the rim portion 23 of the slinger 20, and a gap L₁ in an axial direction between the outer diameter flange 11a of the reinforcing ring 11 and the protrusion portion 23a in the rim portion 23, in place of the outer seal lip 24 in FIG. 1.

In particular, also in this embodiment, the outer diameter portion of the reinforcing ring 11 of the oil seal 10 is extendedly provided with the outer diameter flange 11a and the outer diameter tube portion 11b which are exposed from the outer peripheral seal portion 12 made of the rubber-like elastic material. Describing in detail, the outer diameter flange 11a of the reinforcing ring 11 extends in a radial direction along the leading end of the opening end portion 2a of the housing 2, and the cylindrical outer diameter tube portion 11b directed to an opposite side to the opening end portion 2a is extended from the outer diameter end portion thereof. In other words, the outer diameter flange 11a (and the outer diameter tube portion 11b) is attached to the housing 2 by being integrally provided on the reinforcing ring 11 of the oil seal 10.

Further, a rim portion 23 extending so as to be directed to an opposite side to the outer diameter flange 11a of the reinforcing ring 11 is formed in an outer diameter portion of the seal flange portion 22 in the slinger 20, and the rim portion 23 has a protrusion portion 23a, a cross sectional shape of which is formed in an approximately U-shaped fold shape protruding toward the outer diameter flange 11a side. Further, the protrusion portion 23a is nearby opposed to the outer diameter flange 11a in an axial direction, and the rim portion 23 is nearby opposed to an inner peripheral surface of the outer diameter tube portion 11b of the reinforcing ring 11 in a radial direction.

In this case, it is desirable to make the gap L₁ in the axial direction between the protrusion portion 23a and the outer diameter flange 11a and the gap L₂ in the radial direction between the rim portion 23 and the outer diameter tube portion 11b shown in FIG. 3 as small as possible in the light of the sealing performance, however, the gap L₁ is set to about 0.5 to 3.5 mm and the gap L₂ is set to about 1 to 2 mm, in order to prevent the protrusion portion 23a and the rim portion 23 from coming into contact with the outer diameter flange 11a and the outer diameter tube portion 11b, by taking into consideration a slight eccentricity between the housing 2 and the rotating shaft 3, a displacement and a slight inclination caused at a time of pressure inserting the oil seal 10 and the slinger 20, and the like.

In the sealing device 1 in accordance with the second embodiment constructed as mentioned above, the oil seal lip 13 of the oil seal 10 is structured such as to prevent the lubricating oil fed to the bearing 4 from leaking through the outer periphery of the sleeve 5 to the external portion A, at the sliding portion S₁ with the outer peripheral surface of the sleeve 5. Further, the side lip 15 of the oil seal 10 is structured such as to block the intrusion of muddy water or the like to the inner peripheral side on the basis of the close contact sliding motion with the seal flange portion 22 and the throwing off action of the seal flange portion 22 by centrifugal force at the sliding portion S₂ with the seal flange portion 22 of the rotating slinger 20, and the dust lip 14 of the oil seal 10 is structured such as to block the intrusion of muddy water or the like to the oil seal lip 13 side by being closely opposed to the outer peripheral surface of the sleeve 5 or being slidably brought into close contact with the outer peripheral surface of the sleeve 5, at the inner peripheral side of the side lip 15.

Further, since the labyrinth-shaped non-contact seal is formed by the gap L₁ in the axial direction between the protrusion portion 23a of the slinger 20 and the outer diameter flange 11a of the reinforcing ring 11 and the gap L₂ in the radial direction between the rim portion 23 of the slinger 20 and the outer diameter tube portion 11b of the reinforcing ring 11, at the outer side from the sliding portions of the oil seal lip 13, the dust lip 14 and the side lip 15, the intrusion of muddy water or the like coming in splashily from the external portion A is effectively prevented. Particularly, since a width of the labyrinth-shaped non-contact seal is increased by the protrusion portion 23a and the rim portion 23, a shielding effect with respect to a large foreign material or the like becomes high.

Further, in the gaps L₁ and L₂, since the scattering of muddy water is small on the basis of the labyrinth seal action, a violent beating flow is hard to be generated in an outer peripheral space B of the side lip 15. Accordingly, an abrasion of the side lip 15 is suppressed.

Further, since the protrusion portion 23a and the rim portion 23 of the rotating slinger 20 and the outer diameter flange 11a and the outer diameter tube portion 11b of the non-rotating reinforcing ring 11 are in non-contact with each other, the sliding torque is not generated, so that a specific fuel consumption is not lowered.

### Example

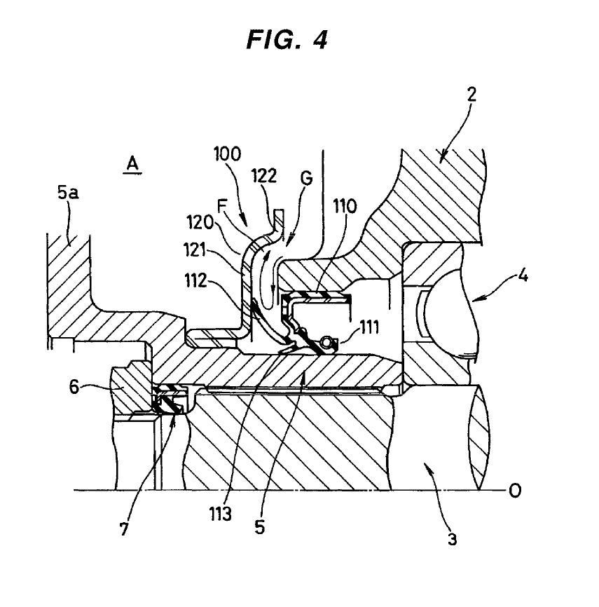

A test for confirming the effect obtained by the present invention was executed. The test employed an example in which the oil seal lip 13 and the dust lip 14 were removed from the specification shown in FIG. 1, and a comparative example in which the oil seal lip 111 and the dust lip 113 were removed from the conventional specification shown in FIG. 4. An operation was made in a state of being submerged in muddy water to a height of an approximately horizontal axis O, and a time until the intrusion of muddy water through the side lips 15 and 112 was recognized, was measured. A test condition is as follows.

Shaft rotating speed: 1500 rpm

Operation pattern: 1 min stop after 23 hour and 59 min operation for 1 cycle

Temperature: natural temperature rising

Muddy water concentration: JIS8 12.5%

Muddy water amount: center of shaft

As a result of the test mentioned above, the intrusion of muddy water was recognized 24 hour after starting the operation in the comparative example, however, the intrusion of muddy water was not recognized even at a time point when 70 hour had passed after starting the operation in the example.

1. A sealing device comprising:
an oil seal attached to an inner peripheral surface of an opening end portion of a non-rotating housing; and
a slinger attached to a rotating body inserted to said housing so as to be positioned at an outer side in an axial direction of said oil seal,
said oil seal being integrally formed on a reinforcing ring made of a metal by a rubber-like elastic material,
wherein an oil seal lip slidably brought into close contact with an outer peripheral surface of said rotating body is formed, an outer diameter flange, which is exposed from said rubber-like elastic material and extends to an outer diameter side, and an outer diameter tube portion, which is directed to an opposite side to the opening end portion of said housing from an outer diameter end portion thereof and extends in such a manner as to surround an outer peripheral side of said slinger, are formed in said reinforcing ring, a cross sectional shape of a rim portion of said slinger is formed in an approximately U-shaped fold shape protruding toward the outer diameter flange side of the reinforcing ring, and an outer seal lip provided on said rim portion so as to be directed to an opposite side to the opening end portion of said housing is slidably brought into close contact with an inner peripheral surface of said outer diameter tube portion.

2. A sealing device comprising:
an oil seal attached to an inner peripheral surface of an opening end portion of a non-rotating housing;
a slinger attached to a rotating body inserted to said housing so as to be positioned at an outer side in an axial direction of said oil seal; and
an outer diameter flange attached to said housing so as to be positioned at an outer diameter side of said oil seal,
wherein said oil seal has an oil seal lip slidably brought into close contact with an outer peripheral surface of said rotating body, an outer diameter tube portion extending so as to be directed to an opposite side to the opening end portion of said housing from an outer diameter end portion thereof is provided extendedly on said outer diameter flange, a protruding portion formed in an approximately U-shaped fold shape protruding toward the outer diameter flange side of the reinforcing ring in its cross sectional shape and nearby opposed to said outer diameter flange via a gap in an axial direction, and a rim portion nearby opposed to an inner peripheral surface of said outer diameter tube portion via a gap in a radial direction, are formed on an outer diameter portion of said slinger, and a labyrinth-shaped non-contact seal is formed by said gap in the radial direction and the gap in the axial direction.
